(19) United States
(12) Patent Application Publication
(10) Pub. No.: US 2014/0314340 A1
(43) Pub. Date: Oct. 23, 2014

(54) REINFORCED BAGS

(71) Applicant: Harry B. Wilfong, Hartsville, SC (US)

(72) Inventor: Harry B. Wilfong, Hartsville, SC (US)

(73) Assignee: Hilex Poly Co. LLC, Hartsville, SC (US)

(21) Appl. No.: 14/213,319

(22) Filed: Mar. 14, 2014

Related U.S. Application Data
(60) Provisional application No. 61/800,032, filed on Mar. 15, 2013.

(51) Int. Cl. B65D 33/00; B31B 1/90; B31B 41/00; B31B 1/64; B65D 33/06; B31B 1/14

(52) U.S. Cl. CPC B65D 33/00; B65D 33/065; B31B 1/14; B31B 41/00; B31B 1/64; B31B 1/90
USPC 383/8; 383/120; 493/194; 493/210

(57) ABSTRACT

Bags having reinforcement tabs are disclosed along with methods of their manufacture.

### CROSS-REFERENCE TO RELATED APPLICATION

This application is a non-provisional application of U.S. Provisional Application No. 61/800,032, filed Mar. 15, 2013, which is hereby incorporated by referenced in its entirety.

### BACKGROUND

Many commercial establishments, such as retail stores, as well as consumers use bags for transporting articles such as groceries and other items. The present invention is directed to reinforced bags for carrying articles.

### SUMMARY OF THE INVENTION

The present invention is for reinforced bags as more fully set forth herein. Generally, the invention is directed to a bag having two exterior faces, an open mouth end defined by the exterior faces, a sealed bottom end joining the exterior faces, at least one gusset extending between the mouth end and the sealed bottom end and defining an inner gusset point, and at least one tab affixed to the bag at the location where an inner gusset point intersects the bottom seal, wherein the tab is formed from bag material. The bag may have handles and a handle cut-out region and the tab may be formed from a removed handle-mouth portion of a bag.

In addition, the invention is directed to a method for reinforcing a gusseted bag, the process comprising the steps of cutting a tab from bag material, and affixing at least one tab to the gusseted bag at a location at which an inner gusset point of the bag intersects with a bottom seal of the bag.

Another method for manufacturing a reinforced gusseted bag is comprised of the steps of forming a plastic tube, gusseting the plastic tube to form at least a first gusset, cutting a portion of tubing to form a tab, wherein the tab is cut from the tubing on three sides, folding the tab about its uncut side to overlay the bag at the point where an inner gusset of the first gusset will intersect with a heat seal, and forming a heat seal on the plastic tube to form a bottom seal end of a bag.

The present invention may be better understood by reference to the description and figures that follow. It is to be understood that the invention is not limited in its application to the specific details as set forth in the following description and figures. The invention is capable of other embodiments and of being practiced or carried out in various ways.

### BRIEF DESCRIPTION OF THE DRAWINGS

These and other features, aspects, and advantages of the present invention are better understood when the following detailed description is read with reference to the accompanying drawings, wherein:

FIG. 1A is a front view of a t-shirt bag having gussets;

FIG. 1B is an end view of the bag shown in FIG. 1A;

FIG. 2A is a perspective view of an embodiment of a reinforced bag of the present invention;

FIG. 2B is a perspective view of the bag of FIG. 2A;

FIG. 2C is an end view of the bag of FIG. 2A;

FIG. 3A is a perspective view of an embodiment of a reinforced bag of the present invention;

FIG. 3B is a perspective view of the bag of FIG. 3A;

FIG. 3C is an end view of the bag of FIG. 3A;

FIG. 4 is a view of two adjoined bags illustrating the formation of an embodiment of forming a reinforced bag of the present invention; and

FIG. 5 is a view of an embodiment of a reinforced bag of the present invention and an exemplary embodiment of a method of its manufacture.

### DETAILED DESCRIPTION OF EXEMPLARY EMBODIMENTS

Reference will now be made in detail to various embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

The use of reference characters with the same two ending digits as other reference characters to indicate structure in the present specification and drawings, without a specific discussion of such structure, is intended to represent the same or analogous structure in different embodiments.

Referring to FIGS. 1A and 1B, bag 100, which is illustrated as a t-shirt-type bag, is shown. As illustrated, bag 100 has an open mouth end 102 and a sealed bottom end 104 at opposing longitudinal ends. In some embodiments, sealed bottom end 104 may be formed by a heat seal. Bag 100 also includes faces 106 (with a front face shown and a rear face, not shown, on the rear side of the bag). Bag 100 also has laterally-spaced, upwardly extending handle portions 108. Such handles may be formed by removing a portion of material from a collapsed tube of plastic otherwise having a “pillowcase” shape to form a “u-shaped” portion that results in the handles and mouth end 102 of bag 100. Each handle portion 108 may include an aperture portion 110 for mounting a bag or a stack of bags on a dispensing rack system. In addition, bag 100 may include a central tab 112 having a slit or aperture 114 for mounting the bag on a dispensing rack system. In some embodiments, central tab 112 may be integral to bag 100 while in other embodiments central tab 112 may be detachably connected to bag 100, such as by way of a perforation line or an aperture that separates central tab 112 from bag 100 upon tearing. As shown in FIG. 1, bag 100 also includes gussets 116, which have an inner gusset point 116′. Bag 100 is shown in a closed configuration in which the bag is not opened, i.e., front and rear faces 106 are back-to-back and the gussets are not open.

As is apparent from FIGS. 1A and 1B, the gusseted portions of bag 100 include four plies (or layers) film when the bag is viewed from a side or end and the region between the gusseted portions includes two plies. As a result, a heat seal or other seal-forming sealed bottom end 104 must seal differing amounts of layers across the bottom of the bag. In addition, due to stresses exerted during use of the bag, it is known that locations at which uneven layers of a bag are sealed at the bottom of a bag, such as shown by points A in FIG. 1A, may be weak and subject to tearing. Such tearing may result in decreased bag performance and even bag failure. Embodiments of the present invention provide reinforced bags.

In one embodiment of the present invention, bag material may be used to reinforce a bag. As used herein, “bag material” references material having the same composition as the bag. In some embodiments, bag material may be scrap or waste from the manufacture of a particular bag, wherein the scrap includes portions of bags that have been discarded during a bag manufacturing processes. For example, in one embodiment, material may be removed from a bag being manufactured to form the “u-shaped” cut-out area, which forms the handles and mouth of a bag. For reference herein, such removed material in that region is referenced as the “removed handle-mouth portion”, and such portions may be used as the bag material for reinforcement as contemplated by the present invention.

In some embodiments, tabs may be prepared from bag materials, such as the u-shaped cut-out discussed above, and one or more tabs may be affixed to a bag, such as at a weak spot, to reinforce the bag. Such tabs may be of any suitable shape, such as, without limitation, circular, semi-circular, square, rectangular, or triangular. In addition, such tabs may be of any suitable size for any given application.

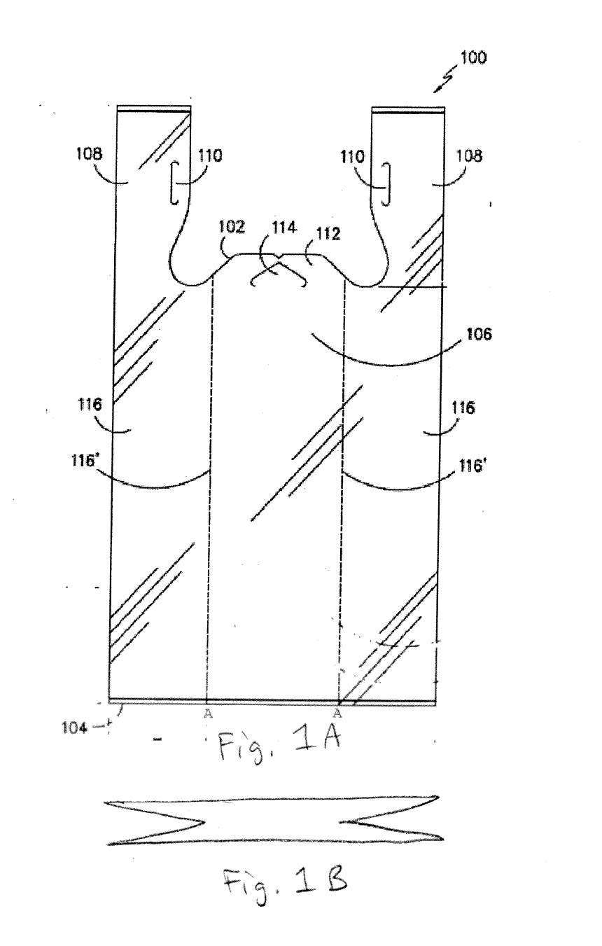

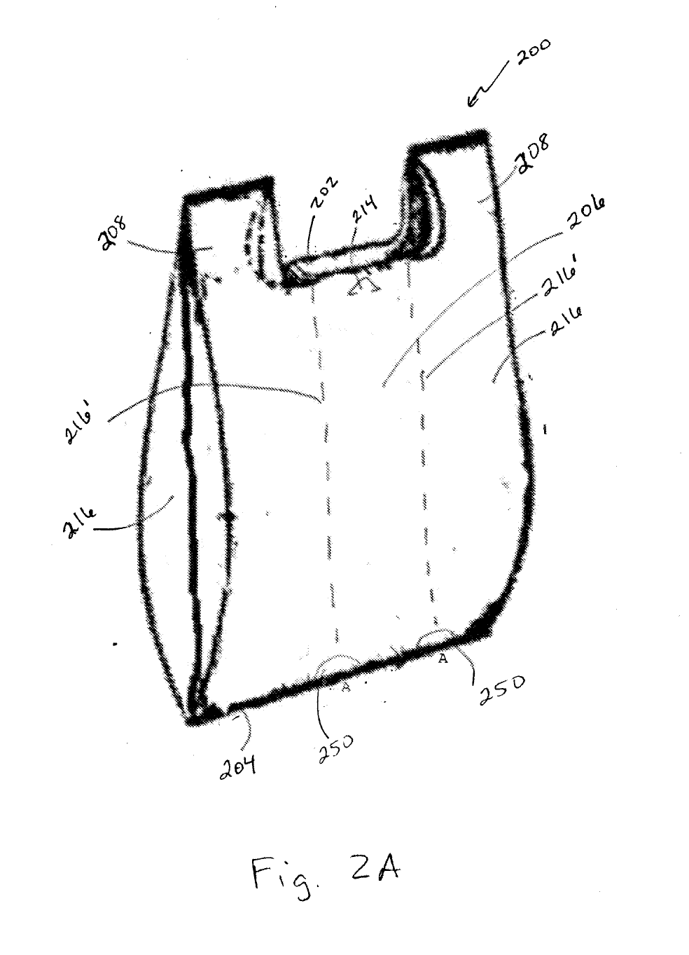

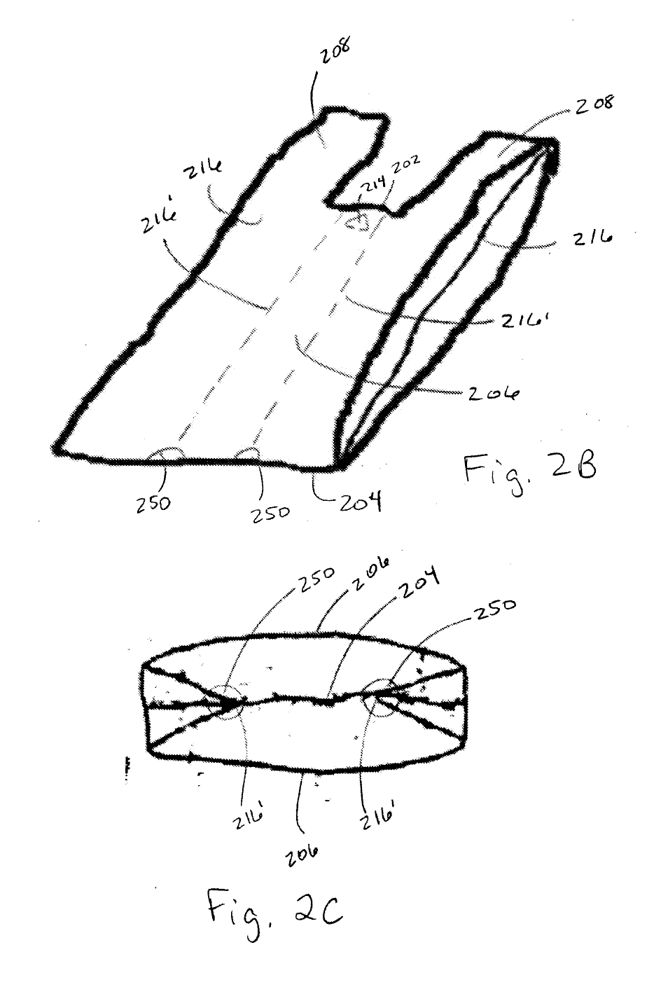

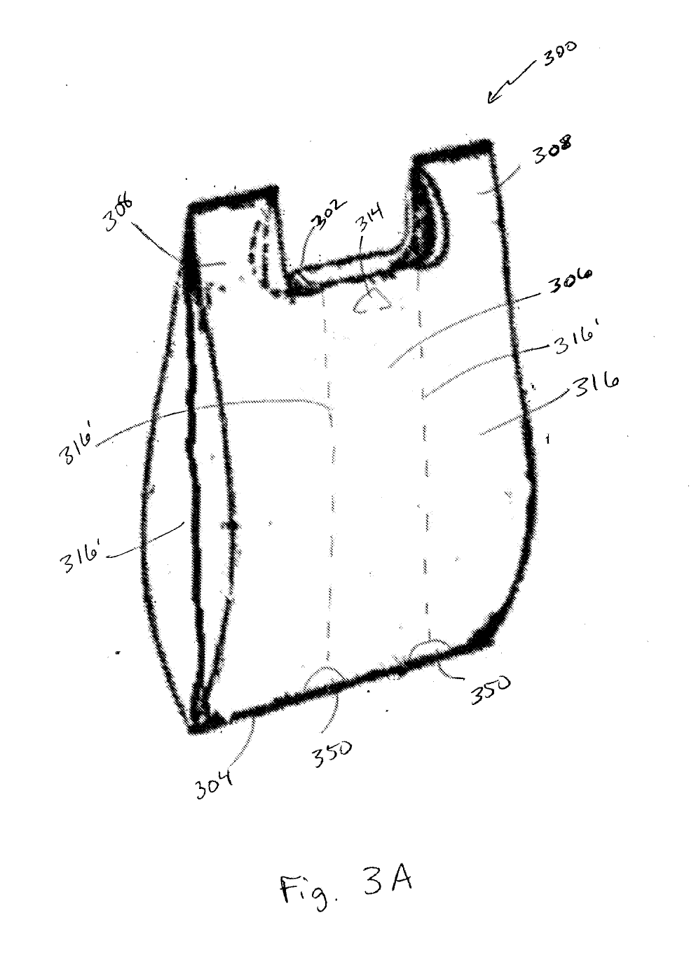

By way of example, FIG. 2 depicts an exemplary embodiment of a reinforced bag of the present invention. As shown in FIG. 2A, bag 200 as illustrated in FIG. 1 has tabs 250 affixed at each of point A, which are known to be a weak spot during use due to the varying layers sealed together at the bottom of the bag. As further shown in FIGS. 2B and 2C, tabs 250 may have a generally circular shape and wrap around the sealed bottom end 104 of bag 100 to provide a semi-circular portion on each bag face. The depicted tabs may be cut from the removed handle-mouth portion that was removed from the bag during its manufacture.

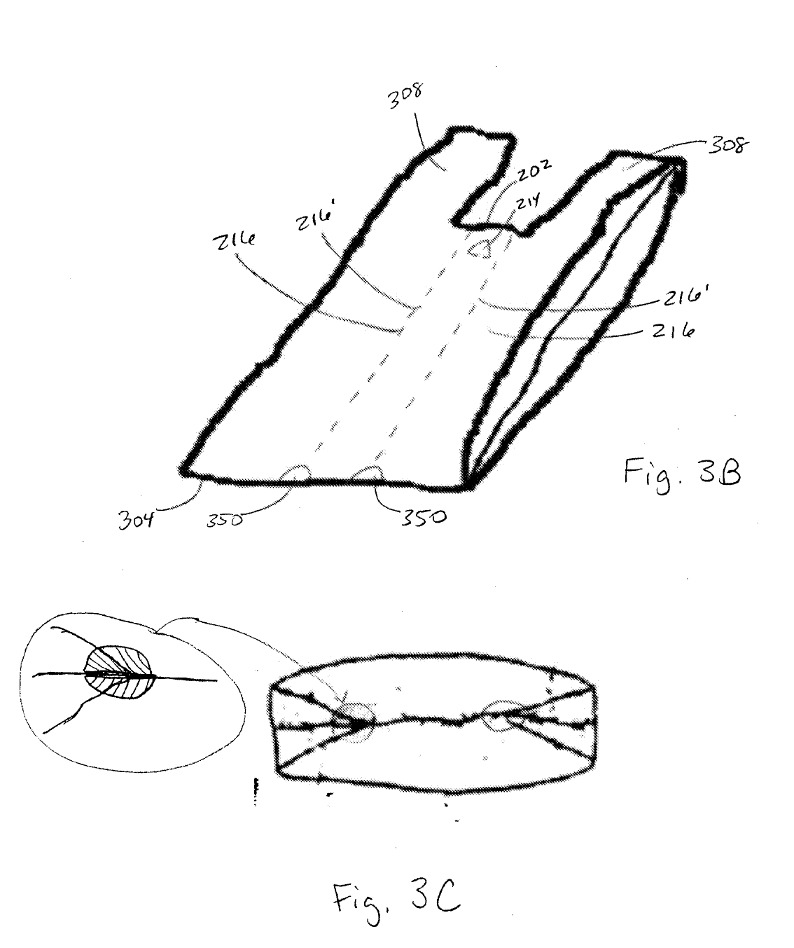

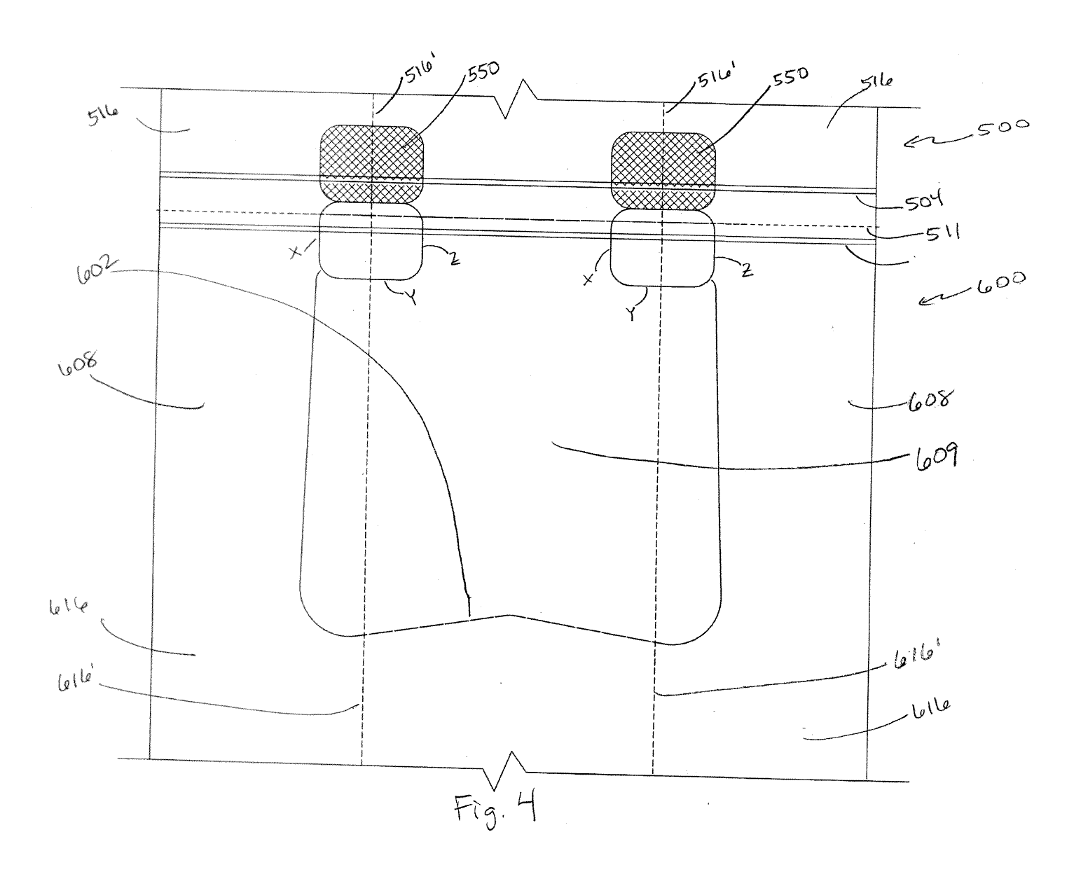

FIGS. 3A-3C illustrate an alternative embodiment of the present invention. As shown in those figures, bag 300 includes tabs 350, each of which has a generally semi-circular shape (as shown in the expanded view) as opposed to being a full circle. In addition, this exemplary embodiment shows one tab affixed to bag 100 on each side of point A such that tabs 350 do not overlap the bottom of bag 100.

One of ordinary skill in the art would readily appreciate that the foregoing embodiments are exemplary and that variations thereto are within the scope of the present invention. For example, and without limitation, alternatively shaped and sized tabs may be used in other embodiments. For example, square-shaped, rectangular-shaped, triangular-shaped, and various elongated-shaped tabs are all among the exemplary shapes that may be employed. In addition, some embodiments may include additional tabs. In some embodiments, a tab may be affixed and positioned on a bag to reinforce more than one weak point of the bag. In still other embodiments, multiple tabs may be applied to a single weak point.

In some embodiments of the present invention, a bag may have a portion of material that extends below the sealed bottom of the bag. In such embodiments, a tab may be affixed to such portion of the bag. In addition, in some embodiments, a tab may wrap around such portion in the manner described above.

With reference to FIG. 4, the present invention also includes an additional method for reinforcing bag. In bag manufacturing processes, bags may be formed from a tube of plastic, such as by gusseting the plastic tube, heat sealing the tube to form a bottom of the bag, and removing the removed handle-mouth portion to form handles and a mouth of the bag. In addition, bags may be cut or perforated from the adjacent portions of the plastic tube, which is used to form bags in the same manner.

As shown in FIG. 4, a partial front view of bag 500 and bag 600 is shown, wherein bag 500 and bag 600 are adjacent and connected, such as may be the case during the manufacture of plastic bags from a tube of plastic film. With reference to FIG. 4, bag 500 is shown having sealed bottom end 504, gussets 516, and inner gusset points 516′. Similarly, bag 600 is shown having gussets 616, inner gusset points 616′, open mouth end 602, handle portions 608, a top seal 603, and removed handle-mouth portion 609 (in which removed handle-mouth portion 609 has not yet been removed from the tube from which bag 609 will be formed). Tear line 511 separates bag 500 and bag 600, and tear line 609 may be a cut line or a perforated line (and in some embodiments tear line 511 may not be formed until after tab 550 is formed and affixed as described below).

In some embodiments, tab 550 may be cut in the manner shown in FIG. 4, in which three sides (indicated as X, Y, and Z) 550 are cut from the bag material below sealed bottom end 504 and from bag material from removed handle-mouth portion 609 (prior to its removal from the bag) to form tab 550. Then, tab 550 may be folded about its uncut edge and affixed to bag 500 at the junction of inner gusset point 516 and sealed bottom end 504 (as indicated by the cross-hatched region in FIG. 4). In this regard, for descriptive purposes only, FIG. 4 illustrates both the cut lines X, Y, and Z for tab 550 and tab 550 as affixed to bag 500. In alternative embodiments, removed handle-mouth portion 609 could be cut in a shape to form tab 550 without additional cutting. In addition, tab 550 may be folded either before or after sealed bottom end 504 is formed.

In another embodiment, tab 550 may be folded along the tear line 511 such that tab 550 is formed solely from bag material from removed handle-mouth portion 609 of bag 600. In still another embodiment, tab 550 may be formed solely from bag material located below sealed bottom end 504 of bag 500 and tear line 511, such that tab 550 is formed from bag material taken solely from bag 500. In such an embodiment, tab 550 may be cut on three sides and folded as described above. In addition, in some embodiments, bag material described herein may be entirely cut on all sides and then removed and affixed to a bag.

As shown, tabs 550 are formed by cutting only three sides of the tab and then folding and affixing it in the cross-hatched region. In some embodiments, tabs 550 may be formed and affixed on both the front and a back side of a bag (wherein the back side is not shown in FIG. 4).

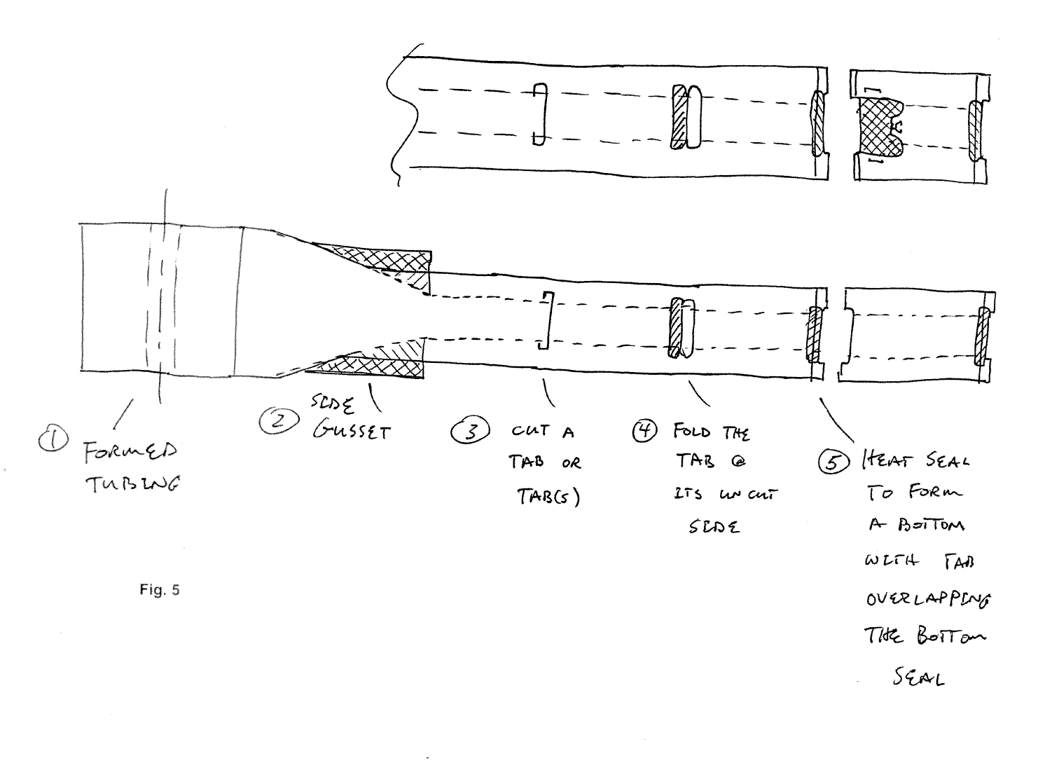

FIG. 5 depicts an additional embodiment of the present invention and a method of its manufacture. As shown in FIG. 5, a bag 700 has a tab 750 that is composed of bag material and that extends to span across the two gusset points depicted. As further shown, the area of the adjacent bag in the manufacturing process from which bag material for tab 750 is taken may ultimately become a removed handle-mouth region. In some embodiments, the manufacturing steps may be practiced in the following order:
1. Form tubing;
2. Form at least one, and optionally two, side gussets in the tubing;
3 Cut a tab or tabs in the tubing, such as by cutting three adjoining cuts in a u-shape in the plastic tubing;
4. Fold the tab at its uncut side;
5. Heat seal the plastic tubing to form a sealed bottom end, wherein the heat seal may optionally overlap the folded tab; and
6. Optionally die cutting a mouth region of the bag and removing a handle-mouth portion.

In some embodiments, tabs of the present invention may be affixed to a bag using any conventional practices or materials. In some embodiments, tabs may be heated and melded to a bag. In other embodiments, tabs may be attached by adhesives, stitching, heat sealing, or using any other suitable methods or combination of methods.

In addition to individual bags, embodiments of the present invention include bag stacks, also called bag packs, in which a plurality of bags are stacked adjacently. Bag stacks may contain any number of bags that are reinforced as described herein and, in some exemplary embodiments, a bag stack may contain 50 bags, 100 bags, or more bags.

Bags and bag stacks of the present invention may be made using any conventional techniques known in the art, such as those described in U.S. Pat. No. 5,335,788 and U.S. Pat. No. 5,562,580, each of which is incorporated herein in its entirety by reference thereto. In addition, as indicated above, bag materials used to make the tabs described herein may have the same composition as the underlying bag to which the tab is applied. Suitable bag materials bag may include any polymeric materials, including polyolefins. By way of example, and without limitation, bag materials may include polyethylenes such as linear low density polyethylene (LLDPE), low density polyethylene (LDPE), high density polyethylene (HDPE), high molecular weight high density polyethylene (HMW-HDPE), and combinations thereof. One of ordinary skill in the art will readily appreciate that other materials may be suitable, such as other thermoplastic materials, including copolymers.

Although the foregoing examples are shown with respect to T-shirt bags, one of ordinary skill in the art will appreciate that the invention may also be used on other types of bags, such as, but not limited to, produce bags in a stack, produce bags on a roll, shopping bags on a roll, and other bag types. In addition, one of ordinary skill in the art will appreciate that the reinforcing tabs of the present invention may be used to reinforce areas of a bag other than those specifically described in the examples.

The foregoing description of illustrative embodiments of the invention has been presented only for the purpose of illustration and description and is not intended to be exhaustive or to limit the invention to the precise forms disclosed. Numerous modifications and adaptations thereof will be apparent to those of ordinary skill in the art without departing from the scope of the present invention.

It will be understood that each of the elements described above, or two or more together, may also find utility in applications differing from the types described. While the invention has been illustrated and described in the general context of mixing in wastewater treatment systems and processes, it is not intended to be limited to the details shown since various modifications and substitutions can be made without departing in any way from the spirit and scope of the present invention. As such, further modifications and equivalents of the invention herein disclosed may occur to persons skilled in the art using no more than routine experimentation, and all such modifications and equivalents are believed to be within the spirit and scope of the invention as described herein.

What is claimed is:

1. A bag comprising:
two exterior faces,
an open mouth end defined by the exterior faces,
a sealed bottom end joining the exterior faces,
at least one gusset extending between the mouth end and the sealed bottom end and defining an inner gusset point, and
at least one tab affixed to the bag at the location where an inner gusset point intersects the bottom seal, wherein the tab is formed from bag material.

2. The bag of claim 1 wherein the bag is a T-shirt bag having handles and a handle cut-out region.

3. The bag of claim 2 wherein the tab is formed from removed handle-mouth portion of a bag.

4. The bag of claim 2 wherein the bag material is scrap material.

5. The bag of claim 2 wherein the tab has a shape selected from the group consisting of circular, semi-circular, square, rectangular, and triangular.

6. The bag of claim 2 wherein the tab is affixed on the two exterior faces of the bag and extends around the sealed bottom end of the bag adjacent to point at which the inner gusset point intersects the bottom seal.

7. The bag of claim 6 further comprises at least two gussets and at least two inner gusset points, wherein at least a second tab is affixed on the two exterior faces of the bag and extends around the sealed bottom end of the bag adjacent to a second point at which a second inner gusset point intersects the bottom seal.

8. The bag of claim 2 wherein at least one tab is affixed on a first exterior face of the bag at a first location at which the inner gusset point intersects the bottom seal and at least one tab is affixed on a second exterior face of the bag at a second location at which the inner gusset point intersects the bottom seal.

9. A method for reinforcing a gusseted bag, the process comprising:
cutting a tab from bag material, and
affixing at least one tab to the gusseted bag at a location at which an inner gusset point of the bag intersects with a bottom seal of the bag.

10. The method of claim 9 wherein the tab is cut from the removed handle-mouth portion of a bag.

11. The method of claim 9 wherein the tab is cut from the removed handle-mouth portion of an adjacent bag that was adjacent to the bag during a bag manufacturing process.

12. The method of claim 9 wherein the tab is cut from the removed handle-mouth portion of the bag.

13. The method of claim 9 wherein the tab is cut from an area in the tube that is located below where a bottom seal of the bag will be formed.

14. A method for manufacturing a reinforced gusseted bag, the process comprising:
forming a plastic tube,
gusseting the plastic tube to form at least a first gusset,
cutting a portion of tubing to form a tab, wherein the tab is cut from the tubing on three sides, and
folding the tab about its uncut side to overlay the bag at the point where an inner gusset of the first gusset will join a heat seal; and
forming a heat seal on the plastic tube to form a bottom seal end of a bag.

15. The method of claim 14 wherein the tubing is cut from an area in the tube that is located below where a bottom seal of the bag will be formed.

16. The method of claim 14 wherein the tubing is cut from an area in the tube that will form the handle-mouth portion of an adjacent bag formed in the tube.

17. The method of claim 14 wherein the tubing is cut from an area in the tube that is located below where a bottom seal of the bag will be formed and form an area in the tube that will form the handle-mouth portion of an adjacent bag formed in the tube.

18. The method of claim 14 wherein the bag material is comprised of material from the group consisting of linear low density polyethylene, low density polyethylene, high density polyethylene, high molecular weight high density polyethylene, and combinations thereof.
